(19) United States
(12) Patent Application Publication
(10) Pub. No.: US 2008/0056236 A1
(43) Pub. Date: Mar. 6, 2008

(54) Unified IMS supplementary services signaling across circuit and packet domains

(76) Inventors: Deborah Lewandowski Barclay, Winfield, IL (US); Michael Francis Dolan, Bolingbrook, IL (US); Richard Paul Ejzak, Wheaton, IL (US); Robin Jeffrey Thompson, Batavia, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/513,922

(22) Filed: Aug. 31, 2006

(51) Int. Cl. H04L 12/66

(52) U.S. Cl. 370/352

(57) ABSTRACT

The present invention provides a method for signaling between an IP Multimedia Subsystem (IMS) and a multi-mode terminal using concise primitives to support the use of IMS-based services while the multi-mode terminal is attached to either the packet switched (PS) domain or to the circuit switched (CS) domain, or moves between these domains. The present invention enables the maintenance of services state in only the IMS and in the multi-mode terminal, thus avoiding the creation or transfer of services state information as the multi-mode terminal moves between the PS and CS domains.

### FIELD OF THE INVENTION

The present invention relates generally to providing unified access to and continuity of supplementary services via an efficient signaling mechanism as a terminal moves between the packet and circuit domains of a network.

### BACKGROUND OF THE INVENTION

With the advent of IP-based services in telephony networks, there arises the issue of providing access to and continuity of supplementary services as a terminal moves between the packet switched (IP-based) domain and the legacy circuit-switched domain of a network. This issue is two-fold. Uniform access to supplementary services is required from both the circuit and packet domains. Supplementary services and unified access to them must continue transparently as a terminal transitions between circuit-switched and packet-switched access networks.

Legacy circuit-switched networks will continue to exist for some years. Terminals are being designed that can attach both to the newer access networks that provide services using Internet Protocol (IP) capabilities, and to older legacy circuit-switched networks. Legacy circuit-switched (CS) terminals obtain services via a mobile switching center (MSC). Terminals that support packet-switched (PS) capabilities can access the IP Multimedia Subsystem (IMS) for services. Multi-mode terminals need to provide the ability to attach to either the PS or CS domain, and to move between those domains while supplementary services are active. Such supplementary services, for example, might include “call hold” or “call waiting” features.

CS domains will, in general, only support a single active voice call (both voice bearer and signaling) between the terminal device and the CS network. PS domains often support multiple bearer and signaling paths to the terminal device. This is possible in the PS domain because of the higher bandwidth normally available between the device and the network.

Due to limitations in the deployed CS networks, and to the desire to minimize impacts to those deployed networks, a method of communication between the multi-mode terminal and IMS that will provide such consistent supplementary services to the terminal user has not been discovered previously. The IMS signaling uses the SIP protocol, whose messages tend to be very large. While transmission of such SIP messages can be managed over the PS network, their transmission over CS networks can be burdensome, and can impact or interrupt active services such as a voice call due to limited bandwidth over such CS networks.

The industry has considered ways to use the larger SIP protocol while the multi-mode terminal is attached to the PS domain, and smaller legacy signaling while the multi-mode terminal is attached to the CS domain. This leads, however, to the need to transfer or create services state information within the two domains separately. Such transfer or creation of services state information is complex, and can lead to significant changes to deployed legacy equipment. One problem within the circuit switched domain relates to transmission techniques.

Therefore, a need exists for a signaling method that provides concise, efficient signaling that can be used in both the packet switched domain and in the circuit switched domain. Further, a need exists for a signaling method for use in transitions between those domains without modification to the signaling method.

### BRIEF SUMMARY OF THE INVENTION

The present invention provides a signaling method that allows a multi-mode terminal and an IMS network to communicate using small messages in order to initiate, manage, and terminate services within the IMS on behalf of the terminal user. The signaling method is used for such communication via both a packet switched domain and a circuit switched domain, and also in transitions between such domains. Because it is possible that transmission bandwidths may be limited in some packet switched networks, an exemplary embodiment of the present invention is also applicable to and useful for transitions between separate packet switched networks.

Specifically, the signaling method of an exemplary embodiment of the present invention between the IMS and the multi-mode terminal supports signaling primitives that request concise actions on the part of the IMS, or on the part of the multi-mode terminal. Such conciseness allows messaging to be much smaller than SIP signaling that might achieve an equivalent or similar result. In addition, the signaling primitives that can be defined can avoid much or all of the bi-directional messaging that characterizes the SIP protocol. Along with each signaling primitive are zero or more parameters that may be needed to accomplish the action of the primitive at either the IMS or at the multi-mode terminal.

An exemplary embodiment of the present invention provides concise signaling between the IMS and the multi-mode terminal that can be transported via both the PS and CS domains, the services state is maintained in only the IMS and in the multi-mode terminal, regardless of whether the services are invoked while the multi-mode terminal is attached via the PS or the CS domain. This avoids the transfer or creation of services state as the multi-mode terminal moves between attachments to the PS and CS domains.

### BRIEF DESCRIPTION OF THE SEVERAL VIEWS OF THE DRAWINGS

FIG. 1A depicts an exemplary message flow using the SIP protocol that illustrates the notification of a multi-mode terminal of a second voice call that is waiting while the multi-mode terminal is active in a first voice call in a CS domain.

FIG. 1B depicts an exemplary message flow that illustrates the notification of a multi-mode terminal of a second voice call that is waiting while the multi-mode terminal is active in a first voice call in the CS domain in accordance with an exemplary embodiment of the present invention.

FIG. 2A depicts an exemplary message flow using the SIP protocol that illustrates the actions of a multi-mode terminal to place a first voice call on hold and to activate a second voice call while attached to a CS domain.

FIG. 2B depicts an exemplary message flow that illustrates the actions of a multi-mode terminal to place a first voice call on hold and to activate a second voice call while attached to the CS domain in accordance with an exemplary embodiment of the present invention.

FIG. 2C depicts an exemplary message flow using the SIP protocol that illustrates the actions of a multi-mode terminal while attached to a CS domain to terminate a second voice call and to reactivate a first voice call that had been on hold.

FIG. 2D depicts an exemplary message flow that illustrates the actions of a multi-mode terminal while attached to the CS domain to terminate a second voice call and to reactivate a first voice call that had been on hold in accordance with an exemplary embodiment of the present invention.

FIG. 3A depicts an exemplary illustration of the use of an exemplary embodiment of the present invention within a packet-switched domain.

FIG. 3B depicts an exemplary illustration of the use of an exemplary embodiment of the present invention within a circuit-switched domain.

FIG. 3C depicts an exemplary illustration of the use of an exemplary embodiment of the present invention that includes transition from a packet-switched domain to a circuit-switched domain.

### DETAILED DESCRIPTION OF THE INVENTION

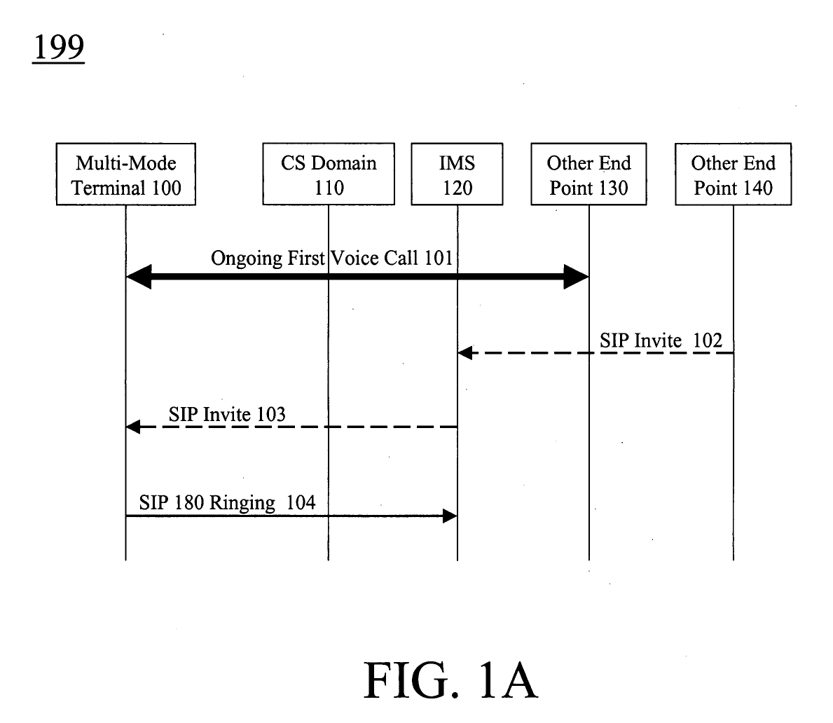

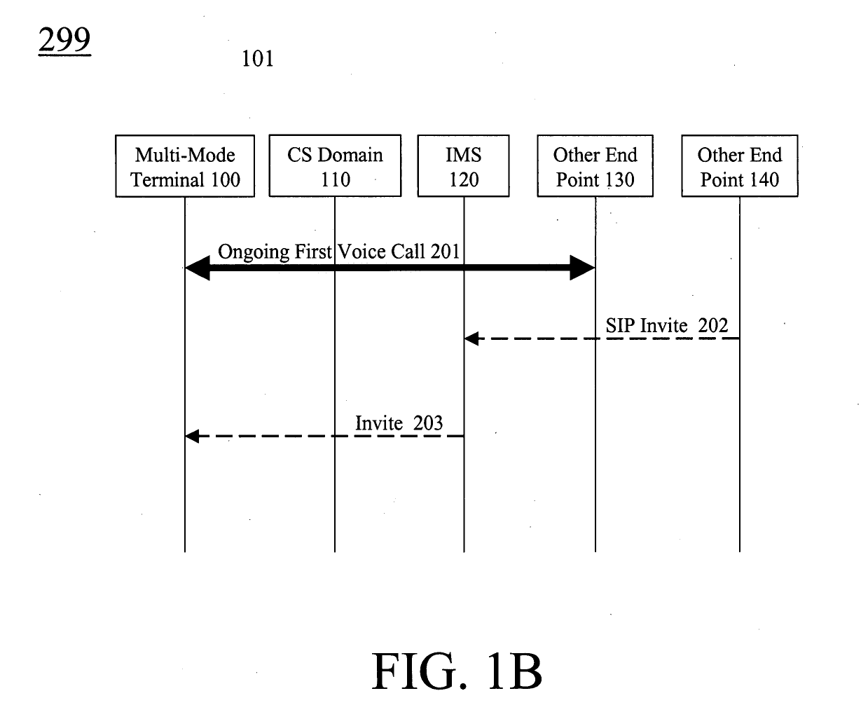

FIG. 1A depicts an exemplary message flow 199 using the SIP protocol that illustrates the notification of a multi-mode terminal 100 of a second voice call 101 that is waiting while the multi-mode terminal 100 is active in a first voice call 101 in CS domain 110. It is assumed that a signaling relationship based on SIP has been established between Multi-Mode Terminal 100 and IMS 130.

Other End Point 140 sends SIP Invite message 102 to IMS 120. SIP Invite message 102 is a request to establish a call between Other End Point 140 and Multi-Mode Terminal 100.

IMS 120 processes SIP Invite message 102 and sends SIP Invite message 103 to Multi-Mode Terminal 100 via CS Domain 110. SIP Invite message 102 preferably includes the directory number of Other End Point 140.

SIP Invite message 103 may be over 1000 octets in length. The bandwidth available through CS domain 110 typically provides 100 octets per second transmission bandwidth. Thus, it may require 10 seconds or more to deliver SIP Invite message 103 to Multi-Mode Terminal 100.

Multi-Mode Terminal 100 responds to SIP Invite message 103 with SIP 180 Ringing message 104. This message indicates that Multi-Mode Terminal 100 has received SIP Invite message 103 and is ringing Multi-Mode Terminal 100.

FIG. 1B depicts an exemplary message flow 299 that illustrates the notification of Multi-Mode Terminal 100 of a second voice call that is waiting while Multi-Mode Terminal 100 is active in a first voice call 201 in CS domain 110 with Other End Point 130 using transport via Circuit Switched Domain 110. First voice call 201 utilizes a signaling relationship between IMS 120 and Multi-Mode Terminal 100 based on an exemplary embodiment of the present invention.

Other End Point 140 sends SIP Invite message 202 to IMS 120. SIP Invite Message 202 is a request to establish a call between Other End Point 140 and Multi-Mode Terminal 100.

IMS 120 processes SIP Invite message 202 and sends a concise message 203 to Multi-Mode Terminal 100 via CS Domain 110. Concise message 203 includes an action primitive of “call-waiting” and two parameter values, “calling line number” and “calling party identification”.

Concise message 203 is typically tens of octets in length. Given the bandwidth available through CS domain 110, it is likely that this entire message may be transmitted to multi-mode terminal 100 in less than one second. If CS domain 110 includes a radio interface, it is likely that this entire message can be sent as a single transmission unit.

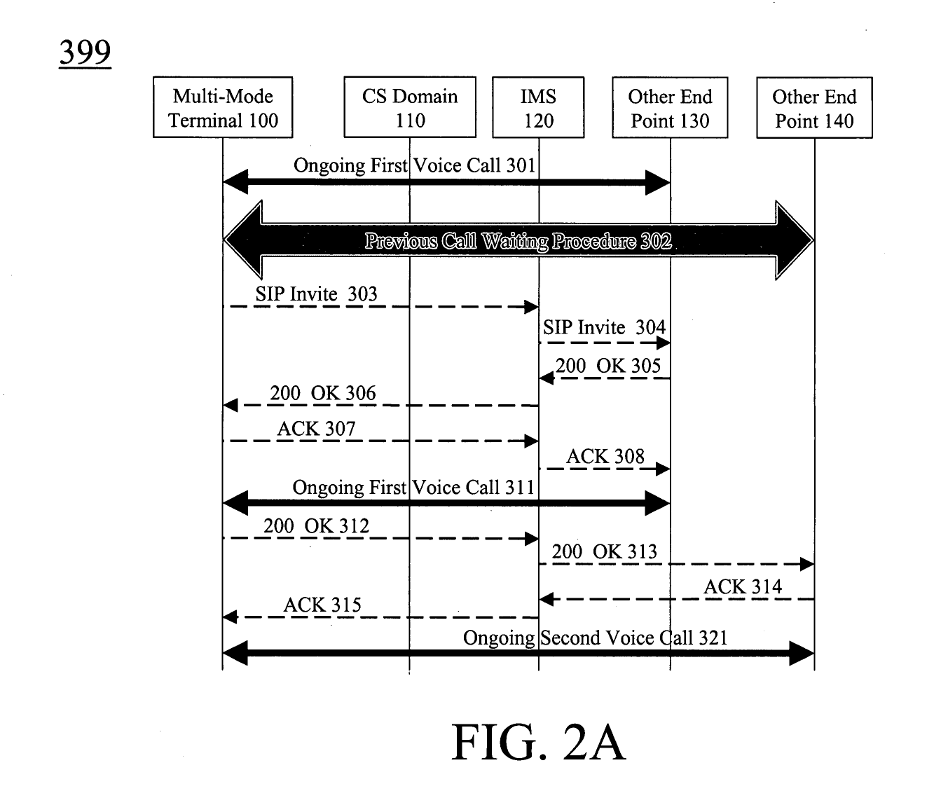

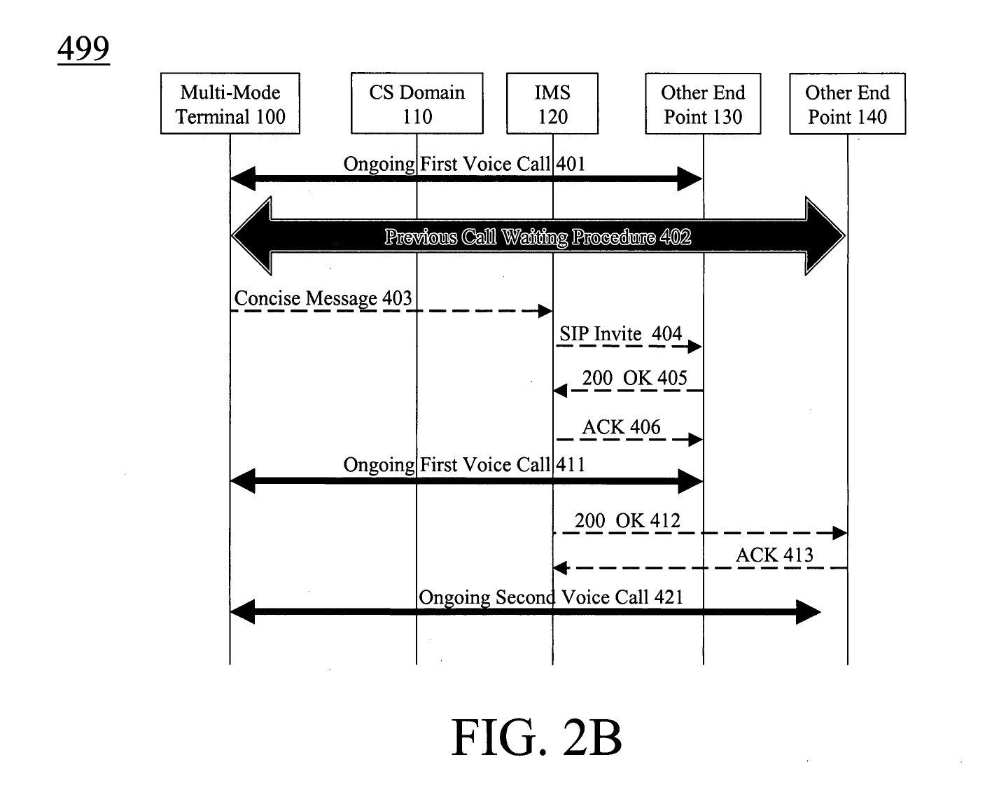

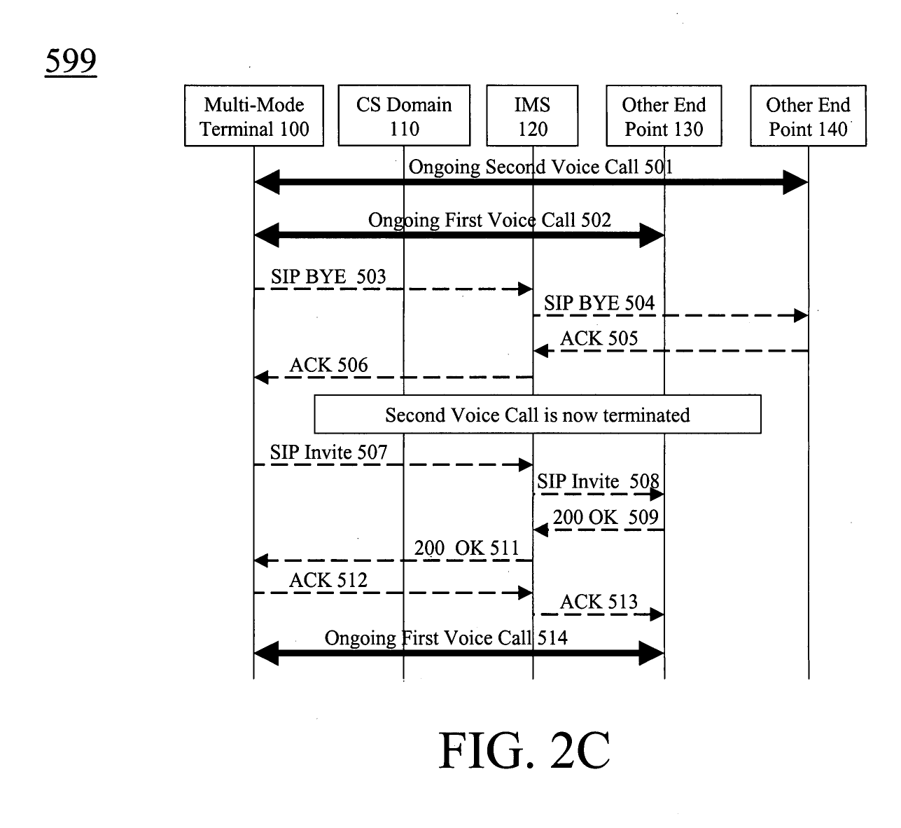

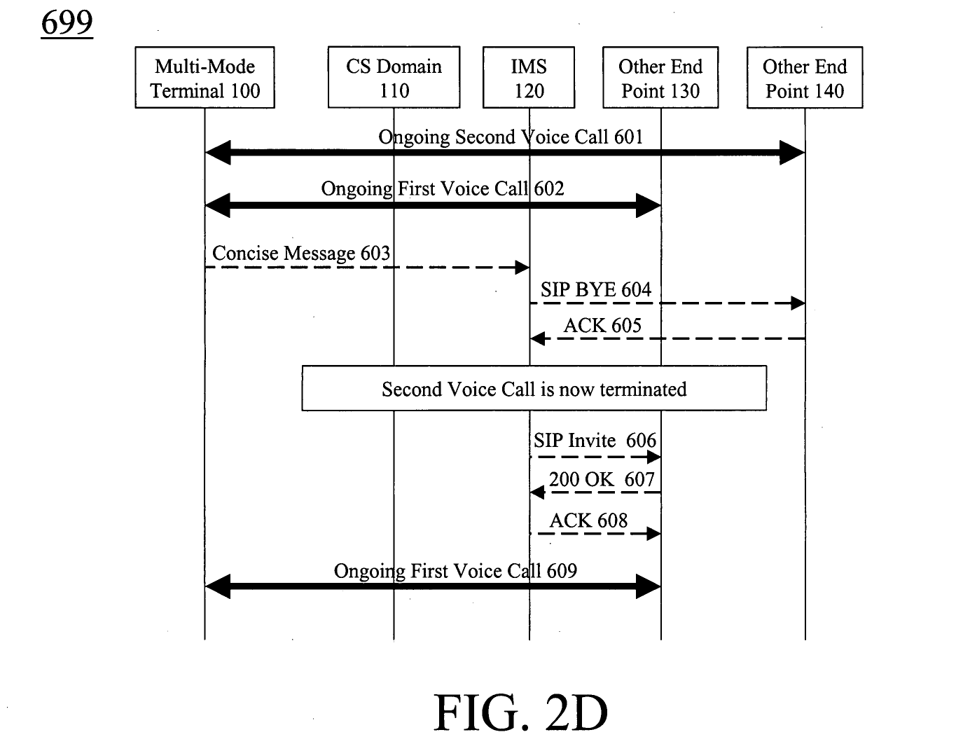

FIG. 2A depicts an exemplary message flow 399 using the SIP protocol that illustrates the actions of Multi-Mode Terminal 100 when placing a first voice call on hold and activating a waiting second voice call while attached to CS domain 110.

First Voice Call 301 is ongoing between Multi-Mode Terminal 100 and Other End Point 130. A call waiting procedure 302 occurs between Multi-Mode Terminal 100 and Other End Point 140, for example utilizing the procedure depicted in FIG. 1A.

Multi-Mode Terminal 100 sends a SIP Invite message 303 to IMS 120 via CS domain 110 to cause the First Voice Call 301 to be placed in a hold state. This is preferably accomplished by specifying a “sendonly” SDP value in SIP Invite message 303.

IMS 120 transmits SIP Invite Message 304 to Other End Point 130 to cause the audio bearer to be held. SIP Invite Message 304 preferably includes an SDP value of “sendonly”.

Other End Point 130 responds with a SIP 200 OK message 305 having an SDP value of “receiveonly” to IMS 120 to acknowledge the SIP Invite Message 304.

IMS 120 forwards SIP 200 OK message 306 to Multi-Mode Terminal 100 via CS domain 110. SIP 200 OK message 306 preferably includes an SDP value of “receiveonly”.

Multi-Mode Terminal 100 responds to SIP 200 OK message 306 with SIP ACK message 307 sent via CS domain 110 to IMS 120.

IMS 120 forwards SIP ACK message 308 to Other End Point 130.

At this point, the ongoing first voice call is now placed on hold 311, such that the audio path is now inactive between Multi-Mode Terminal 100 and Other End Point 130.

Multi-Mode Terminal 100 accepts the waiting Second Voice Call by sending SIP 200 OK message 312 to IMS 120 via CS domain 110.

IMS 120 forwards SIP 200 OK message 313 to Other End Point 140.

Other End Point 140 responds with SIP Acknowledgement (ACK) message 314 sent to IMS 120.

IMS 120 forwards SIP ACK 315 to Multi-Mode Terminal 100 via CS domain 110.

At this point, an ongoing Second Voice Call 321 exists between Multi-Mode Terminal 100 and Other End Point 140, as well as a held First Voice Call between Multi-mode Terminal 100 and Other End Point 130. The audio path between Multi-Mode Terminal 100 and Other End Point 140 is now active.

In accordance with the specification of the SIP protocol, the five SIP messages in this scenario between Multi-Mode Terminal 100 and IMS 120 will be hundreds of octets in length. The bandwidth available through CS domain 110 typically provides 100 octets per second transmission bandwidth. Thus, it may require five or more seconds or more to deliver the SIP messages between Multi-Mode Terminal 100 and IMS 120.

Message flow 399 occurs with Multi-Mode Terminal 100 and IMS 120 transmitting SIP signaling via PS domain 510 without modification to the signaling when Multi-Mode Terminal 100 is operating in PS mode.

FIG. 2B depicts an exemplary message flow 499 that illustrates the actions of a multi-mode terminal 100 to place a First Voice Call 401 on hold and to activate a waiting Second Voice Call 421 while attached to CS domain 110 in accordance with an exemplary embodiment of the present invention.

In accordance with an exemplary embodiment, an ongoing First Voice Call 401 exists between Multi-Mode Terminal 100 and an Other End Point 130.

A call waiting procedure 402 occurs between Multi-Mode Terminal 100 and Other End Point 140, for example, according to the procedure of FIG. 1B.

Multi-Mode Terminal 100 sends a concise message 403 to IMS 120 via CS domain 110. This causes the First Voice Call to be placed in a hold state and accepts the waiting Second Voice Call offer from Other End Point 140 as follows.

IMS 120 transmits SIP Invite message 404 with a “sendonly” SDP value to Other End Point 130 to cause the audio bearer of first voice call 401 to be held.

Other End Point 130 responds with a SIP 200 OK message 405 with a “receiveonly” SDP value to IMS 120 to acknowledge the request.

IMS 120 sends a SIP ACK 406 to Other End Point 130. The audio path of First Voice Call 401 is now being held 411.

IMS 120 sends a SIP 200 OK message 412 to the Other End Point 140 to accept the Second Voice Call.

Other End Point 140 responds with a SIP Acknowledgement (ACK) message 413 sent to IMS 120.

An ongoing Second Voice Call 421 has now been established between Multi-Mode Terminal 100 and Other End Point 140. Ongoing Second Voice Call 421 includes an active audio path between Multi-Mode Terminal 100 and Other End Point 140. In addition, there is also a held First Voice Call 411 between Multi-mode Terminal 100 and Other End Point 130. The exemplary embodiment depicted in FIG. 2B includes only one concise message 403 sent between Multi-Mode Terminal 100 and IMS 120. In addition, the one concise message 403 sent can be extremely small, occupying only tens of octets, thus requiring less than one second to deliver.

Message flow 499 preferably occurs with Multi-Mode Terminal 100 and IMS 120 transmitting concise signaling via PS domain 510 without modification to the signaling when Multi-Mode Terminal 100 is operating in PS mode.

FIG. 2C depicts an exemplary message flow 599 using the SIP protocol that illustrates the actions of multi-mode terminal 100 while attached to CS domain 110 to terminate a second voice call 501 and to reactivate a first voice call 502 that had been on hold, for example according to the procedure depicted in FIG. 2A.

FIG. 2C depicts an ongoing Second Voice Call 501 between Multi-Mode Terminal 100 and Other End Point 140. The audio path between Multi-Mode Terminal 100 and Other End Point 140 is active at this point.

Ongoing First Voice Call 502 has been placed on hold so that its audio path exists but is not active between Multi-Mode Terminal 100 and Other End Point 130.

Multi-Mode Terminal 100 sends a SIP Bye message 503 to IMS 120 via CS domain 110 to terminate Second Voice Call 501.

IMS 120 transmits SIP Bye message 504 to Other End Point 140 to cause Second Voice Call 501 to be terminated.

Other End Point 140 responds with SIP ACK message 505 to IMS 120 to acknowledge the termination of Second Voice Call 501.

IMS 120 forwards SIP ACK message 506 to Multi-Mode Terminal 100 via CS domain 110. At this point, Second Voice Call 501 is terminated.

Multi-Mode Terminal 100 now proceeds to reactivate held First Voice Call 502 by sending a SIP Invite message 507 including non-null bearer values to IMS 120 via CS domain 110.

IMS 120 forwards SIP Invite message 508 to Other End Point 130.

Other End Point 130 responds with SIP 200 OK message 509 sent to IMS 120.

IMS 120 forwards SIP 200 OK message 511 to Multi-Mode Terminal 100 via CS domain 110.

Multi-Mode Terminal 100 sends SIP ACK 512 to IMS 120 via CS domain 110.

IMS 120 forwards SIP ACK 513 to Other End Point 130.

At this point, there exists an ongoing reactivated First Voice Call 514 between Multi-Mode Terminal 100 and Other End Point 130. The audio path between Multi-Mode Terminal 100 and Other End Point 130 is now active.

In this exemplary embodiment, five SIP messages are sent between Multi-Mode Terminal 100 and IMS 120. These SIP messages are hundreds of octets in length, and the bandwidth available through CS domain 110 may only provide 100 octets per second transmission bandwidth. Thus, it may require five or more seconds to deliver this SIP message exchange between Multi-Mode Terminal 100 and IMS 120 via CS domain 110.

Message flow 599 preferably depicts Multi-Mode Terminal 100 and IMS 120 transmitting SIP signaling via PS domain 510 without modification to the signaling when Multi-Mode Terminal is operating in PS mode.

FIG. 2D depicts an exemplary message flow 699 that illustrates the actions of a multi-mode terminal 100 while attached to a CS domain 110 to terminate a second voice call 601 and to reactivate a first voice call 602 that had been on hold, for example according to the procedure depicted in FIG. 2B. Ongoing Second Voice Call 601 is between Multi-Mode Terminal 100 and Other End Point 140. In this exemplary embodiment, ongoing First Voice Call 602 exists between Multi-Mode Terminal 100 and Other End Point 130 and has been placed on hold so that its audio path exists but is not active.

Multi-Mode Terminal 100 sends a concise message 603 to IMS 120 via CS domain 110. Concise message 603 serves to both terminate Second Voice Call 601 and to reactivate the held First Voice Call 602.

IMS 120 transmits SIP Bye 604 to Other End Point 140 to cause Second Voice Call 601 to be terminated.

Other End Point 140 responds with SIP ACK 605 to IMS 120 to acknowledge the termination of Second Voice Call 601. At this point, Second Voice Call 601 is now terminated.

IMS 120 forwards SIP Invite message 606 to Other End Point 130. SIP Invite message 606 preferably includes non-null bearer values.

Other End Point 130 responds by sending SIP 200 OK message 607 to IMS 120.

IMS 120 sends SIP ACK 608 to Other End Point 130. At this point, ongoing First Voice Call 609 is reactivated between Multi-Mode Terminal 100 and Other End Point 130 such that the audio path is now active.

In this exemplary embodiment, only one concise message is sent between Multi-Mode Terminal 100 and IMS 120. This single concise message is preferably extremely small, thus requiring less than one second to deliver the concise message between Multi-Mode Terminal 100 and IMS 120.

Message flow 699 preferably occurs with Multi-Mode Terminal 100 and IMS 120 transmitting concise signaling via PS domain 510 without modification to the signaling when Multi-Mode Terminal 100 is operating in PS mode.

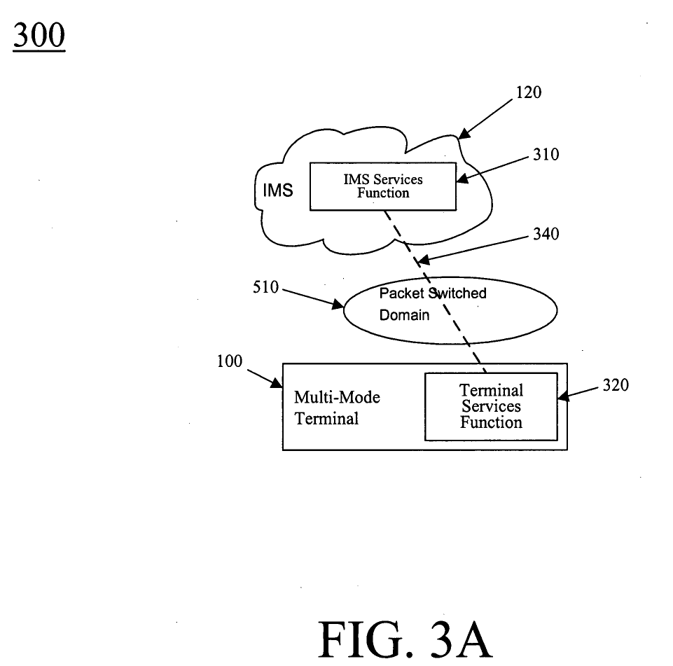

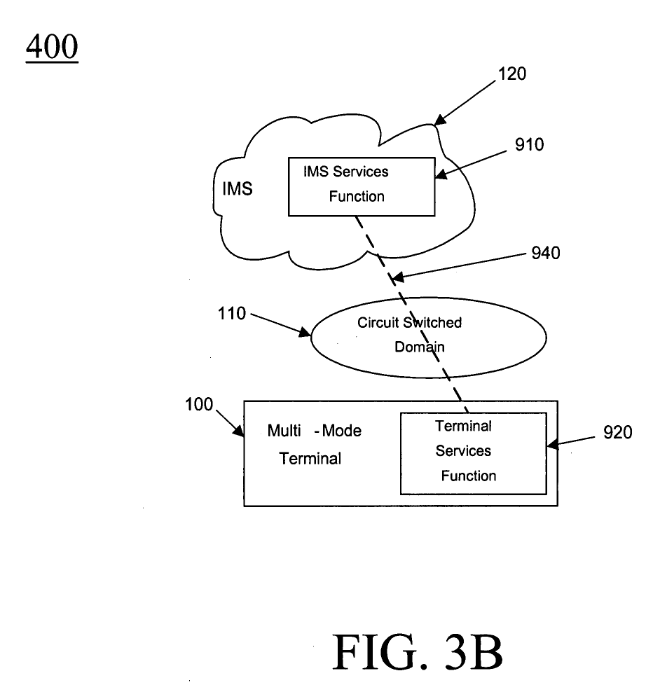

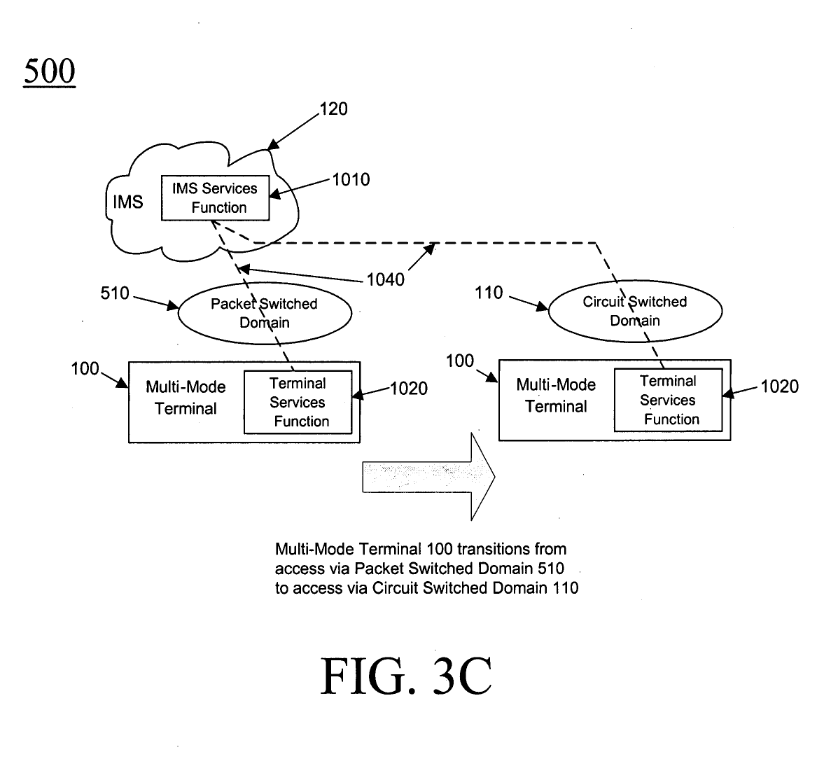

FIG. 3A depicts an exemplary illustration 300 of the use of an exemplary embodiment of the present invention within a packet-switched domain. IMS Services Function 310 exists within IMS 120 and communicates across Packet Switched Domain 510 with Terminal Services Function 320 within Multi-Mode Terminal 100 using a flow of messages 340 created according to this invention.

FIG. 3B depicts an exemplary illustration 400 of the use of an exemplary embodiment of the present invention within a circuit-switched domain. IMS Services Function 910 exists within IMS 120 and communicates across Circuit Switched Domain 110 with Terminal Services Function 920 within Multi-Mode Terminal 100 using a flow of messages 940 created according to this invention.

FIG. 3C depicts an exemplary illustration 500 of the use of an exemplary embodiment of the present invention that includes transition from packet-switched domain to a circuit-switched domain. The same flow of messages 1040 occurs and continues during a transition of Multi-Mode Terminal 100 from Packet Switched Domain 510 to Circuit Switched Domain 110. This flow of messages 1040 continues between IMS Services Function (1010) in IMS 120 and Terminal Services Function 1020 within Multi-Mode Terminal 100 via either Packet Switched Domain 510 or Circuit Switched Domain 110. The methods of transmission of the flow of messages within each of these Domains may differ.

For example, if there exists a voice call between the multi-mode terminal and another terminal device, where the voice call control signaling aspect passes through the IMS, it may be the case that a second voice call is presented to the IMS for delivery to the multi-mode terminal user. While the information on the second voice call, including the calling line number and calling party identification, may be passed from IMS to the multi-mode terminal using SIP, this would require perhaps several hundred octets of messaging be exchanged bi-directionally between the IMS and the multi-mode terminal. For the purposes of maintaining transparency to the IMS when the multi-mode terminal is accessing the IMS services via the CS domain, and to minimize the number of total octets transferred, and the number of messages used, the same information (“call-waiting”, “calling line number”, and “calling party identification”) could be transferred as a single primitive using many fewer octets, and expecting no reply. Failure of the transmission of the single primitive could be noted by Multi-Mode Terminal 100 user and the primitive action repeated via a request from the user.

Use of the smaller, single primitive could be supported equally across the PS and CS domains, thus allowing the IMS to be unaware of the domain to which the multi-mode terminal was currently attached for purposes of signaling the multi-mode terminal concerning the second voice call. See FIGS. 1A and 1B for an example comparing the use of SIP messaging and the use of this invention to support a call-waiting scenario.

As a second example that illustrates the usefulness of this invention as the multi-mode terminal transitions between the PS and CS domains, consider the case of the multi-mode terminal that is involved in a first voice call in the PS domain, and has received notification of a second voice call that is waiting. It is assumed in this example that services remain within the IMS. FIG. 2A illustrates the actions taken using SIP to place the first voice call on hold, and to accept the second voice call. FIG. 2B illustrates the actions taken using this invention to perform the same operations. It should be noted that the differences between FIGS. 2A and 2B are in the size and quantity of messaging between the IMS and the multi-mode terminal. Other messaging based on the SIP protocol within the IMS and to the other end point (OEP) remain identical.

As a continuation of the second example, consider that while the second voice call is active between the multi-mode terminal and the second OEP, the multi-mode terminal transitions from the PS domain to the CS domain. How such a transition is made is not considered in this invention, and has been defined by various standards bodies, including 3GPP and 3GPP2. While the multi-mode terminal is continuing the second voice call via the CS domain, the second voice call ends, and the multi-mode terminal reselects the first voice call and reactivates it. FIGS. 2C and 2D illustrate the signaling that would be required respectively using SIP signaling, and using this invention. It will be observed that the quantity and size of messages using SIP signaling is significant. One skilled in the art will understand and recognize that the bandwidth available to communicate both signaling and voice via the CS domain can be limited, and that a significant amount of such signaling can degrade and interrupt the active voice call. Compared to the use of SIP signaling, the concise signaling provided by this invention is significantly smaller, and will be recognized as having a correspondingly smaller impact on the active voice call by one skilled in the art.

While this invention has been described in terms of certain examples thereof, it is not intended that it be limited to the above description, but rather only to the extent set forth in the claims that follow.

We claim:

1. A method for signaling between an IP Multimedia Subsystem (IMS) and a multi-mode terminal, the method comprising:
sending a signal between the IMS and the multi-mode terminal, the signal including an encoded primitive action; and
receiving the signal.

2. A method for signaling in accordance with claim 1, the method further comprising the step of executing the primitive action by the signal recipient.

3. A method for signaling in accordance with claim 2, wherein the signal further comprises additional values, the additional values being useful in executing the primitive action.

4. A method for signaling in accordance with claim 1, wherein the signal includes a plurality of primitive actions.

5. A method for signaling in accordance with claim 4, wherein the plurality of primitive actions are useful in executing a single primitive action.

6. A method for signaling in accordance with claim 4, wherein the plurality of primitive actions are separately identifiable by the signal recipient.

7. A method for signaling in accordance with claim 1, wherein the step of sending a signal comprises sending the signal in a plurality of separate transmissions.

8. A method for signaling in accordance with claim 7, the method further comprising the step of assembling the plurality of separate transmissions into the signal.

9. A method for signaling in accordance with claim 1, wherein the step of sending a signal between the IMS and the multi-mode terminal comprises sending the signal via a circuit-switched domain.

10. A method for signaling in accordance with claim 9, wherein the step of sending the signal via a circuit-switched domain does not disrupt services being offered by the circuit-switched domain.

11. A method for signaling in accordance with claim 1, wherein the step of sending a signal between the IMS and the multi-mode terminal comprises sending the signal via a packet-switched domain.

12. A method for signaling in accordance with claim 11, wherein the step of sending the signal via a packet-switched domain does not disrupt services being offered by the packet-switched domain.
